(19) United States
(12) Patent Application Publication
(10) Pub. No.: US 2024/0087011 A1
(43) Pub. Date: Mar. 14, 2024

(54) SYSTEM AND METHOD FOR PROVIDING COMPARISON SERVICES FOR INDUSTRY-SPECIFIC CONTEXTUAL TEXT AND OFFICIAL LOAN ESTIMATE

(71) Applicant: Yatin Karnik, Allen, TX (US)

(72) Inventor: Yatin Karnik, Allen, TX (US)

(21) Appl. No.: 17/940,177

(22) Filed: Sep. 8, 2022

(51) Int. Cl. G06Q 40/02; G06Q 40/08; G06Q 50/16

(52) U.S. Cl. CPC G06Q 40/025; G06Q 40/08; G06Q 50/167

(57) ABSTRACT

A system and method for comparison services of industry-specific contextual text and official loan estimate are disclosed. The system comprises a computing device having a processor and a computer-readable medium coupled to the processor. The processor performs comparison services for industry-specific contextual text and official loan estimate from a plurality of lenders/service providers. The computing device is configured to provide a side-by-side comparison for official loan estimate to assist the user to find out a suitable lender having the most beneficial mortgage offer and allow the user to compare the industry-specific contextual text along with an element of time that is relevant to the compared text, thereby allowing the user to determine the comparison parameters and contextual text relevance to overall comparison to select a suitable lender for an appropriate interest rate and all other mortgage services. Further, a mortgage comparison module is used to compare various third-party services.

### FIELD OF THE INVENTION

The present invention generally relates to financial systems and methods for performing financial information. More specifically, the present invention relates to an online financial system and method configured to provide mortgage comparison services for industry-specific contextual text and official loan estimate.

### BACKGROUND

The marketplace or platform for financial products such as mortgage, loan etc., is available. The platform or system compares the loan estimation and provides other services like buying goods and services. Due to the increase of financial crisis, the government has taken some initiatives to overcome it. Title X of the Dodd-Frank Wall Street Reform and Consumer Protection Act creates a new Bureau of Consumer Financial Protection within the Federal Reserve Board as a new supervisor for certain financial firms and as a rule-maker and enforcer against unfair, deceptive, abusive, or otherwise prohibited practices relating to most consumer financial products or services. Also, Consumer Finance Protection Bureau advises not to make a final decision before comparing official Loan Estimates. Later, the loan estimate and closing disclosure forms are released. The forms provide borrowers with important information like actual costs for the loan and to be able to shop lenders around. Further, Freddie Mac's research proves that by comparing just 2 Loan Estimates (LEs) borrowers can save an average of $1,500 and by comparing 5 LEs they can save over $3,000 on their mortgage. But there are no tools or services that allow side-by-side comparison of two LEs.

Few existing patent references attempt to address the problems cited in the background as prior art over the presently disclosed subject matter are explained as follows:

A prior art US 20170161826 A1 to William S. Packer, et. al., entitled “Report generating system for providing real time and/or proactive debt instrument approval, availability, analysis and recommendation to a consumer” discloses a report, loan estimate and approved debt instrument package generating system for determining a preferred, available debt instrument package approved for individual consumers. A typical scenario is a consumer having obtained a loan offer for a mortgage loan on a standardized loan estimate form and utilizing the system disclosed herein, receiving back an analysis of that loan offer with comparison(s) to other available and approved loan offers and/or actually receiving back an alternative lender's loan estimate form and/or actually receiving back alternative loan packages for closing. The system is further configured to monitor, suggest improvements to and provide the ability to change a consumer's fiscal situation in real time.

Another prior art US 20140229364 A1 to David K Moffa, entitled “Mortgage collaborative compliance system and method” discloses a mortgage system including a first module configured to support operating and compliance metrics, a data store configured to store a set of key performance indicators in the mortgage field, a second module configured for data validation and related visualization protocols, and a multi-tier user access authorization module configured to allow data contributors (e.g., mortgage companies) to provide information to clients, auditors, regulators, and/or authorized third parties. A method includes providing a standard set of key performance indicators in the mortgage field to a group of data contributors, receiving data from the group of data contributors, determining one or more performance metrics over a period of time on an absolute basis, determining one or more performance metrics either at a point in time or for a period of time on a relative basis, and displaying a comparison of the one or more determined performance metrics.

Yet another prior art AU 2017100086 A4 to Seoin C. Graham, entitled “Online Financial System” discloses an online financial system and method is provided. The system includes a graphical user interface configured to receive client data, including personal information of a client and data indicative of a current financial situation of the client. A processor is configured to analyze the client data to generate at least one financial proposal, and generate a retirement forecast for the client according to the at least one proposal. The graphical user interface is configured to provide the forecast.

Though the above existing prior art discloses various systems, methods, and techniques to facilitate comparison services for financial transactions, none of them disclose a system and method that allow the customers to digitally compare two or more official Loan estimates at a time to determine which lender or service provider best suits their needs. Also, they lack to disclose a single platform or application with comparison services for loan and contextual, shopping services, customize mortgage, etc.

In light of all the above-mentioned drawbacks, there is a need for a system and method to provide mortgage comparison services for industry-specific contextual text and official loan estimate from two or more lenders. Also, there is a need for a system that allows the customers to compare industry-specific contextual text (Homophones) along with an element of time that is relevant to the compared text.

### SUMMARY OF THE INVENTION

The present invention generally discloses a system and method to provide mortgage comparison services for industry-specific contextual text and official loan estimate. Also, the present invention discloses a system that allows the customers to compare industry-specific contextual text (Homophones) along with an element of time that is relevant to the compared text.

According to the present invention, a computer-implemented system for providing mortgage comparison services for industry-specific contextual text and official loan estimate is disclosed. The system runs in a computer-implemented network environment configured to provide mortgage comparison services in a mortgage marketplace. In one embodiment, the system allows a user to perform mortgage comparison services for industry-specific contextual text and official loan estimate from two or more lenders or service providers. In one embodiment, the system is an application software or web-based application or mobile application or desktop application.

In one embodiment, the network environment comprises one or more user devices. Each user device is associated with a user. In one embodiment, the user device is installed with a dedicated application software (i.e., Confer). The user may be a customer, an end-user, a consumer, or a borrower. In one embodiment, the application software is an official loan estimate comparison tool or service that allows the user to digitally compare one or more official loan estimates. The system further comprises a network and a mortgage comparison management system. In one embodiment, the user device is enabled to access the mortgage comparison management system via the network. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the mortgage comparison management system. In an embodiment, the network could be Wi-Fi, WiMAX, wireless local area network (WLAN), satellite networks, cellular networks, private networks, and the like.

In one embodiment, the mortgage comparison management system comprises a computing device and one or more databases in communication with the computing device. In one embodiment, the computing device is a server. In one embodiment, the computing device could be a cloud server or AWS. In one embodiment, the server could be operated as a single computer. In some embodiments, the computer could be a touchscreen and/or non-touchscreen and adapted to run on any type of OS, such as iOS™, Windows™ Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the database is in communication with the computing device via the network. In one embodiment, the database is accessible by the computing device. In another embodiment, the database is integrated into the computing device or separate from it. In some embodiments, the database resides in a connected server or a cloud computing service. Regardless of location, the database comprises a memory to store and organize certain data for use by the computing device. In one embodiment, the database is configured to store a plurality of information used to perform various comparison services.

In one embodiment, the computing device comprises a computer-readable medium or memory unit and one or more processors coupled to the computer-readable medium. The memory unit stores a set of instructions executable by the processor configured to perform various comparison services for industry-specific contextual text and official loan estimate from a plurality of lenders/service providers. The memory unit could be RAM, ROM (including EPROM, EEPROM, PROM). In one embodiment, the user device is configured to access the services provided by the computing device via the network. In one embodiment, the user device is configured to allow the user to shop for all service providers in one centralized location.

In one embodiment, the computing device is configured to provide a side-by-side comparison for official loan estimate to assist the user to find out a lender has the most beneficial mortgage offer. In one embodiment, the computing device is further configured to allow the user to compare the industry-specific contextual text along with an element of time that is relevant to the compared text, thereby allowing the user to determine the comparison parameters and contextual text relevance to the overall comparison in order to select a suitable lender for an appropriate interest rate and all other mortgage marketplace services. In one embodiment, the mortgage marketplace includes a plurality of options including, but not limited to, lenders/service providers, insurance providers, title/escrow companies, and inspection vendors. The mortgage marketplace enables users to obtain multiple loan estimates on a single credit pull by utilizing a single credit reference number. This eliminates the need to get credit pulled by multiple lenders. Using the mortgage marketplace, users could select a non-standard repayment term length (for example, 226 months) and review how changes will work within their unique financial situation.

In one embodiment, the system further comprises a mortgage comparison module configured to provide comparison of a plurality of third-party services. The plurality of third-party services includes, but are not limited to, title insurance, escrow and closing services, homeowners' insurance, inspection services, and mobile notary services.

In one embodiment, the system further comprises an artificial intelligence (AI) module that evaluates each official loan estimate to identify unallowable fees and analyze fee amounts to alert the user in case of the unallowable or exorbitant fees is present. In one embodiment, the system eliminates over tolerance (OT) losses of lenders participating in the mortgage marketplace as the user selects third-party services. The system allows the lenders to improve their regulatory compliance by eliminating change circumstance validation.

In one embodiment, the system enables the user to digitally compare two or more official loan estimates at a same time to determine a suitable lender or service provider. In one embodiment, the system assists the user to get the suitable service provider and pricing and the lender to mitigate their risk by reducing or eliminating any losses stemming from any fee changes. In one embodiment, the system utilizes one or more push notifications including planned and unplanned events to inform the user during rate-impacting events. In one embodiment, the system allows the user to compare every required service and select the lowest-cost or quickest option, thereby allowing the user to shop all services at the same time without any delay. Further, the mortgage marketplace enables users to receive a pre-approval letter to submit for a home buying offer based on soft credit and successful decision-making using GSE services. The system also evaluates customers' income and debt and completes affordability analysis and the numbers from which will be used for making decisions to deliver the pre-approval letter.

In one embodiment, the present invention further utilizes a method for providing various comparison services for industry-specific contextual text and official loan estimate in a mortgage marketplace. The method for providing various comparison services for industry-specific contextual text and official loan estimate is performed using a computer-implemented system. The system is executed in a network environment. In one embodiment, the system comprises a computing device having a processor coupled with a computer-readable medium. The computer-readable medium stores a set of instructions executable by the processor configured to perform various comparison services for industry-specific contextual text and official loan estimate from a plurality of lenders.

In one embodiment, the system further comprises a database in communication with the computing device via a network. The database is configured to store a plurality of information used to perform various comparison services. In one embodiment, the system further comprises a user device associated with each user or borrower in communication with the computing device via the network. The user device is configured to allow the user to shop for all service providers in one centralized location.

In one embodiment, the method comprises the following steps. At one step, the system provides a side-by-side comparison of official loan estimates from two or more lenders to assist the user to find out a lender has the most beneficial mortgage offer. At another step, the system allows the user to compare the industry-specific contextual text along with an element of time that is relevant to the compared text, thereby allowing the user to determine the comparison parameters and contextual text relevance to the overall comparison in order to select a suitable lender for an appropriate interest rate and all other mortgage services. In one embodiment, the system compares a plurality of third-party services using a mortgage comparison module. In one embodiment, the plurality of third-party services are title insurance, escrow and closing services, homeowners' insurance, inspection services, and mobile notary services.

In one embodiment, the mortgage marketplace includes a plurality of options include lenders, insurance providers, title/escrow companies, and inspection vendors. In one embodiment, the system enables users to digitally compare two or more official loan estimates at a same time to determine a suitable lender or service provider. In one embodiment, the system assists the user to get the suitable service provider and pricing and the lender to mitigate their risk by reducing or eliminating any losses stemming from any fee changes. In one embodiment, the system allows the user to compare every required service and select the lowest-cost or quickest option, thereby allowing the user to shop all services at the same time without any delay.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for providing mortgage comparison services for industry-specific contextual text and official loan estimate in an embodiment of the present invention.

FIG. 2 shows a screenshot of a dashboard in one embodiment of the present invention.

FIG. 3 shows a flowchart of a contextual data flow in one embodiment of the present invention.

FIG. 4 shows a flowchart of a comparison process for comparing one or more official loan estimates in one embodiment of the present invention.

FIG. 5 shows a shop for service module for allowing a user to shop any service in one embodiment of the present invention.

FIG. 6 shows a partner access module in one embodiment of the present invention.

FIG. 7 shows a flowchart of a lender selection process in one embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

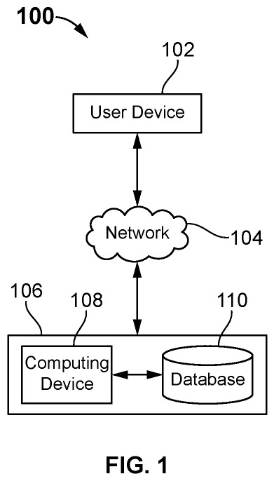

Referring to FIG. 1, a computer-implemented system executed in a network environment 100 for providing mortgage comparison services for industry-specific contextual text and official loan estimate, according to an embodiment of the present invention. The system runs in the computer-implemented network environment 100 configured to provide mortgage comparison services in a mortgage marketplace. In one embodiment, the system allows a user to perform mortgage comparison services for industry-specific contextual text and official loan estimate from two or more lenders or service providers. In one embodiment, the system is an application software or web-based application or mobile application or desktop application.

In one embodiment, the network environment 100 comprises one or more user devices 102. Each user device 102 is associated with a user. In one embodiment, the user device 102 is installed with a dedicated application software (i.e., Confer). The user may be a customer, an end-user, a consumer, or a borrower. In one embodiment, the application software is an official loan estimate comparison tool or service that allows the user to digitally compare one or more official loan estimates. The system further comprises a network 104 and a mortgage comparison management system 106. In one embodiment, the user device 102 is enabled to access the mortgage comparison management system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the mortgage comparison management system 106. In an embodiment, the network 104 could be Wi-Fi, WiMAX, wireless local area network (WLAN), satellite networks, cellular networks, private networks, and the like.

In one embodiment, the mortgage comparison management system 106 comprises a computing device 108 and one or more databases 110 in communication with the computing device 108. In one embodiment, the computing device 108 is a server. In one embodiment, the computing device 108 could be a cloud server or AWS. In one embodiment, the server could be operated as a single computer. In some embodiments, the computer could be a touchscreen and/or non-touchscreen and adapted to run on any type of OS, such as iOS™, Windows™, Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108. In one embodiment, the database 110 is configured to store a plurality of information used to perform various comparison services.

In one embodiment, the computing device 108 comprises a computer-readable medium or memory unit and one or more processors coupled to the computer-readable medium. The memory unit stores a set of instructions executable by the processor configured to perform various comparison services for industry-specific contextual text and official loan estimate from a plurality of lenders/service providers. The memory unit could be RAM, ROM (including EPROM, EEPROM, PROM). In one embodiment, the user device 102 is configured to access the services provided by the computing device 108 via the network 104. In one embodiment, the user device 102 is configured to allow the user to shop for all service providers in one centralized location.

In one embodiment, the computing device 108 is configured to provide a side-by-side comparison for official loan estimate to assist the user to find out a lender has the most beneficial mortgage offer. In one embodiment, the computing device 108 is further configured to allow the user to compare the industry-specific contextual text along with an element of time that is relevant to the compared text, thereby allowing the user to determine the comparison parameters and contextual text relevance to overall the comparison in order to select a suitable lender for an appropriate interest rate and all other mortgage marketplace services. In one embodiment, the mortgage marketplace includes a plurality of options including, but not limited to, lenders/service providers, insurance providers, title/escrow companies, and inspection vendors. The mortgage marketplace enables users to obtain multiple loan estimates on a single credit pull by utilizing a single credit reference number. This eliminates the need to get credit pulled by multiple lenders. Using the mortgage marketplace, users could select a non-standard repayment term length (for example, 226 months) and review how changes will work within their unique financial situation.

In one embodiment, the system further comprises a mortgage comparison module configured to provide comparison of a plurality of third-party services. The plurality of third-party services includes, but are not limited to, title insurance, escrow and closing services, homeowners' insurance, inspection services, and mobile notary services.

In one embodiment, the system further comprises an artificial intelligence (AI) module that evaluates each official loan estimate to identify unallowable fees and analyze fee amounts to alert the user in case of the unallowable or exorbitant fees is present. In one embodiment, the system eliminates over tolerance (OT) losses of lenders participating in the mortgage marketplace as the user selects third-party services. The system allows the lenders to improve their regulatory compliance by eliminating change circumstance validation. In one embodiment, the system enables the user to digitally compare two or more official loan estimates at a same time to determine a suitable lender or service provider.

In one embodiment, the system assists the user to get the suitable service provider and pricing and the lender to mitigate their risk by reducing or eliminating any losses stemming from any fee changes. In one embodiment, the system utilizes one or more push notifications including planned and unplanned events to inform the user during rate-impacting events. In one embodiment, the system allows the user to compare every required service and select the lowest-cost or quickest option, thereby allowing the user to shop all services at the same time without any delay. Further, the mortgage marketplace enables users to receive a pre-approval letter to submit for a home buying offer based on soft credit and successful decision-making using GSE services. The system also evaluates customer's income and debt and completes affordability analysis and the numbers from which will be used for making decisions to deliver the pre-approval letter.

In one embodiment, the present invention further utilizes a method for providing various comparison services for industry-specific contextual text and official loan estimate in a mortgage marketplace. The method for providing various comparison services for industry-specific contextual text and official loan estimate is performed using a computer-implemented system. The system is executed in a computer-implemented network environment. In one embodiment, the system comprises a computing device having a processor coupled with a computer-readable medium. The computer-readable medium stores a set of instructions executable by the processor configured to perform various comparison services for industry-specific contextual text and official loan estimate from a plurality of lenders.

In one embodiment, the system further comprises a database in communication with the computing device via a network. The database is configured to store a plurality of information used to perform various comparison services. In one embodiment, the system further comprises a user device associated with each user or borrower in communication with the computing device via the network. The user device is configured to allow the user to shop for all service providers in one centralized location.

In one embodiment, the method comprises the following steps. At one step, the system provides a side-by-side comparison of official loan estimates from two or more lenders to assist the user to find out a lender has the most beneficial mortgage offer. At another step, the system allows the user to compare the industry-specific contextual text along with an element of time that is relevant to the compared text, thereby allowing the user to determine the comparison parameters and contextual text relevance to the overall comparison in order to select a suitable lender for an appropriate interest rate and all other mortgage services. In one embodiment, the system compares a plurality of third-party services using a mortgage comparison module. In one embodiment, the plurality of third-party services are title insurance, escrow and closing services, homeowners' insurance, inspection services, and mobile notary services.

In one embodiment, the mortgage marketplace includes a plurality of options include lenders, insurance providers, title/escrow companies, and inspection vendors. In one embodiment, the system enables users to digitally compare two or more official loan estimates at a same time to determine a suitable lender or service provider. In one embodiment, the system assists the user to get the suitable service provider and pricing and the lender to mitigate their risk by reducing or eliminating any losses stemming from any fee changes. In one embodiment, the system allows the user to compare every required service and select the lowest-cost or quickest option, thereby allowing the user to shop all services at the same time without any delay.

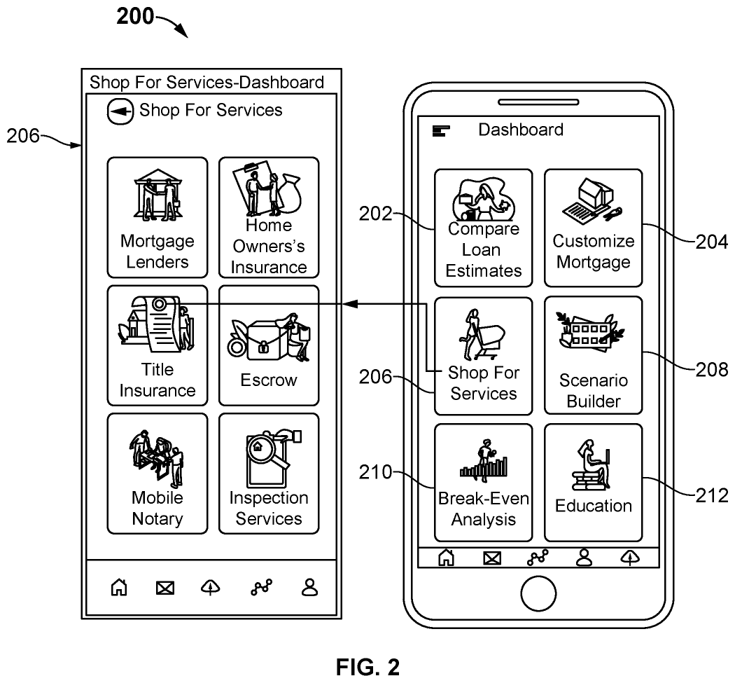

Referring to FIG. 2, a screenshot 200 of a dashboard of the mortgage marketplace/application software, according to one embodiment of the present invention. The application software allows the user to create a user account by registering one or more user credentials such as user name, password, e-mail id, contact number, etc. Upon successful registration, the user is directed to the dashboard. The dashboard comprises one or more options such as compare loan estimate 202, customize mortgage 204, shop for services 206, scenario builder 208, break-even analysis 210, and education 212. In one embodiment, the option “shop for services” 206 comprises one or more services such as mortgage lenders, home owner's insurance, title insurance, escrow, mobile notary, and inspection services. The option “shop for services” 206 allows the user to shop for all service providers in one centralized location. Further, revenue is generated for the application software when a service provider or vendor with a marketing service agreement with the application software is selected in the marketplace. The user could shop for anything they need for their home financing needs. The marketplace could be used by cash buyers who still need other third-party services such as appraisal, title, insurance, and inspection that they need. Currently, the third-parties rely solely on personal recommendations or as most people use a realtor of mortgage loan originators' favorites.

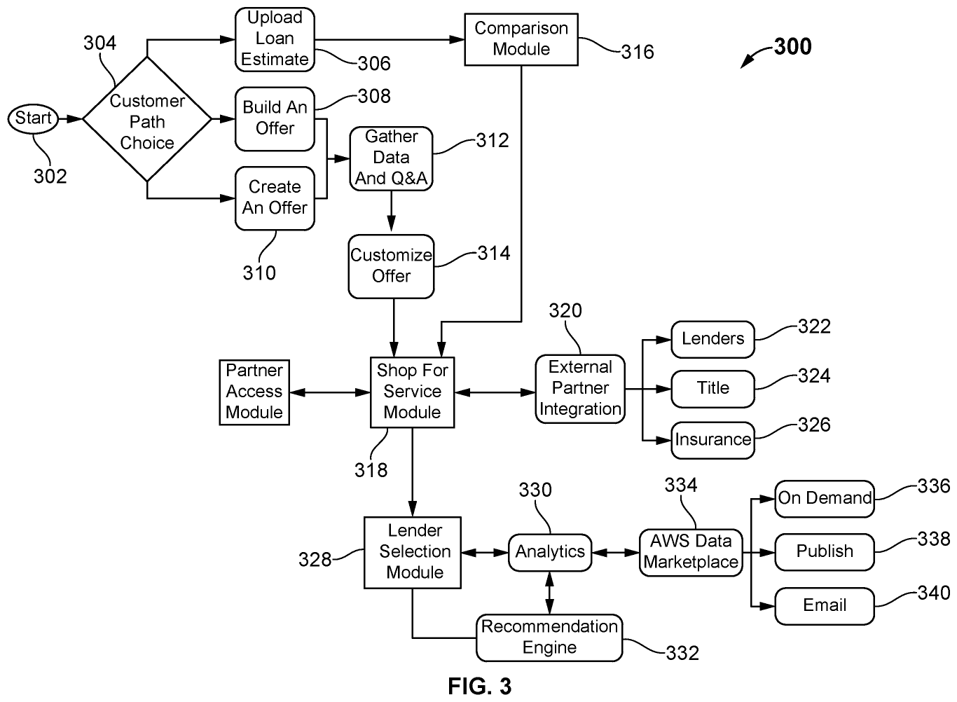

Referring to FIG. 3, a flowchart 300 of a contextual data flow, according to one embodiment of the present invention. The flowchart 300 exemplarily illustrates the data flow while comparing services for industry-specific contextual text and official loan estimates from two or more lenders. In one embodiment, the industry-specific contextual comparison services are provided along with an element of time.

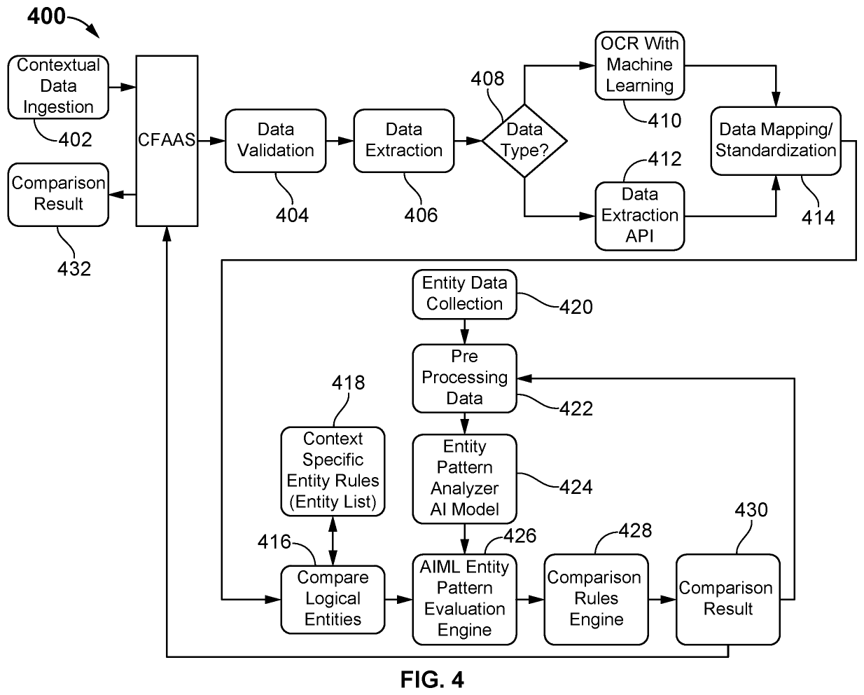

In one embodiment, the flowchart 300 comprises the flowing steps. At step 302, the application software initiates/starts the contextual data flow. At step 304, the application software allows the user to make customer path choice with respect to the next proceeding steps such as uploading a loan estimate 306, building an offer 308, and creating an offer 310. At step 306, the user uploads the official loan estimate, which is directed to a comparison module to perform comparison process (as shown in FIG. 4). At step 308, the application software builds an offer. At step 310, the application software creates an offer. At step 312, the built offer from step 308 and created offer from step 310 are combined to gather data and Q&A. At step 314, a customized offer is generated.

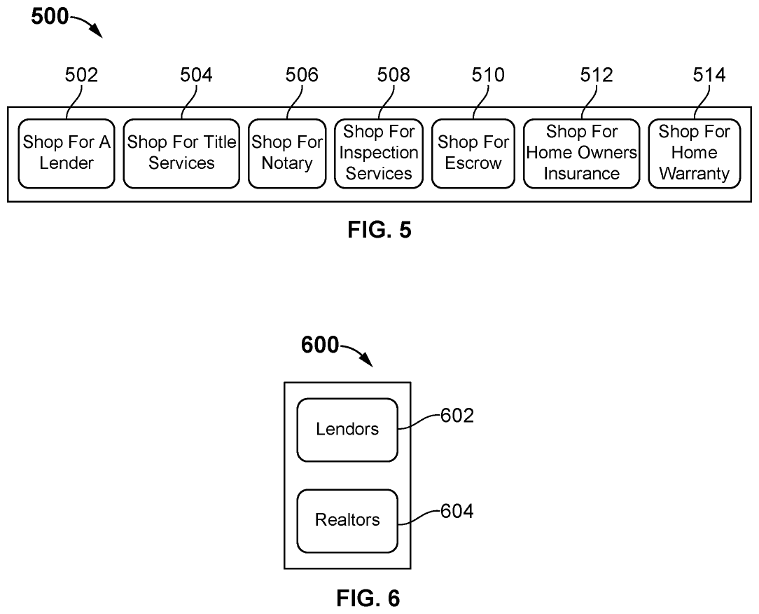

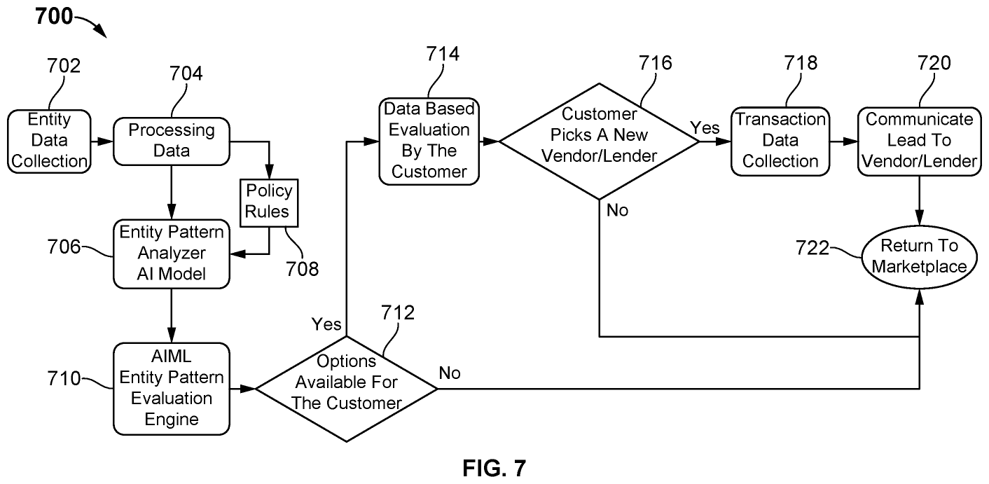

At step 316, the customized offer obtained from step 314 and the comparison result from the comparison process are sent to a shop for services module (as shown in FIG. 5). At step 318, the shop for service module is in communication with a partner access module (as shown in FIG. 6) and an external partner integration module. At step 320, the external partner integration module provides various external partners. At step 322, the external partner integration may be lenders. At step 324, the external partner integration may be title. At step 326, the external partner integration may be insurance. At step 328, the result of shop for service module is directed to lender selection module to perform lender selection process (as shown in FIG. 7). At step 330, the result of the lender selection process is analyzed. At step 332, the analyzed data from step 330 is directed to a recommendation engine either to proceed further or return to the lender selection process. At step 334, the analyzed data is also directed to the AWS data marketplace. At step 336, the data sent to the AWS data marketplace is on demand. At step 338, the data in the AWS marketplace is published. At step 340, the data in the AWS marketplace is sent to the user via e-mail.

Referring to FIG. 4, a flowchart 400 of a comparison process for comparing one or more official loan estimates using a comparison module, according to one embodiment of the present invention. The comparison process comprises the following steps. At step 402, one or more contextual data are ingested to CFAAS. At step 404, the contextual data are validated. At step 406, the validated data are extracted. At step 408, the extracted data type is selected. At step 410, the selected data is sent to OCR with a machine learning (ML) module. At step 412, the selected data is also sent to a data extraction API. At step 414, data mapping/standardization is performed using the data from the previous steps 410 and 412. At step 416, one or more logical entities are compared. At step 418, the logical entities are compared using context-specific entity rules (entity list).

At step 420, data of various entities are collected. At step 422, the entities' data are pre-processed. At step 424, the pre-processed data is sent to the entity pattern analyzer AI model. At step 426, the result from the previous steps 418 and 424 are sent to an AIML entity pattern evaluation engine. At step 428, the pattern evaluation engine sent the entity pattern to a comparison rules engine. At step 430, a comparison result is generated. If a required comparison result is not obtained, the comparison result is fed back to the pre-processing step 422. If the required comparison result is obtained, the comparison result is given to CFAAS. At step 432, the CFAAS presents the comparison result.

Referring to FIG. 5, a shop for service module 500 for allowing the user to shop for any service, according to one embodiment of the present invention. The shop for service module 500 comprises one or more sub-modules including, but are not limited to, shop for lenders 502, shop for title services 504, shop for mobile notary services 506, shop for inspection services 508, shop for escrow 510, shop for homeowner insurance 512, and shop for home warranty 514.

Referring to FIG. 6, a partner access module 600, according to one embodiment of the present invention. In one embodiment, the partner access module 600 comprises one or more sub-modules including, but not limited to, lenders 602 and realtors 604. The system provides the first industry marketplace which enables users to pick a service provider and the fee attached to the service. If a fee for a lender-referred service is under-disclosed to the customer, the lender 602 becomes responsible to pay any fee increases from the initial disclosure. Lenders 602 spend millions of dollars to account for any changes to the fee after it is initially disclosed to the user.

The selection of partner enables the users to choose the service provider and a fee is attached. The application software helps the users and lenders at the same time: The user gets the best service provider and pricing while the lenders 602 mitigate their risk by reducing or eliminating any losses stemming from any fee changes. When the user selects the service provider from the mortgage marketplace, the service is considered borrower-referred and the lender alleviates the risk of any changes that might occur after the initial disclosure. Further, the third-party services such as appraisal, title, insurance, and inspection utilized by the cash buyers solely rely on the personal recommendations or the realtors 604.

Referring to FIG. 7, a flow chart 700 of a lender selection process, according to one embodiment of the present invention. The lender selection process comprises the following steps. At step 702, various data of an entity are collected. At step 704, the entity's data are processed. At step 706, the processed entity's data are sent to an entity pattern analyzer artificial intelligence (AI) model. At step 708, the processed entity's data are sent to the entity pattern analyzer AI model with respect to policy rules. At step 710, the pattern analyzer AI model sends the data to an artificial intelligence machine-learning (AIML) entity pattern evaluation engine. At step 712, the application software provides options to user to proceed further. If yes, the AIML entity pattern evaluation engine sends data to next step 714. If no, the AIML entity pattern evaluation engine sends data to step 722. At step 714, the application software allows the user to evaluate the data from the AIML entity pattern evaluation engine. At step 716, the application software allows the user to select a new vendor/lender. If the user picks the new vendor, the flow proceeds to the next step 718. If the user does not pick the new vendor, the flow proceeds to step 722. At step 718, the transaction data are collected. At step 720, the application software allows the user to communicate with the selected vendor/lender. At step 722, upon the selection of the suitable vendor/lender, the flow returns to the marketplace.

According to the present invention, the user benefits from the comparison service by shopping for interest rates and all other services. In one embodiment, the system utilizes an artificial intelligence (AI) module that works based on RESPA-TILA rules configured to catch any irregularities with non-bonafide fees. In one embodiment, the lenders who participate in the mortgage marketplace may benefit from the comparison service by eliminating their over tolerance (OT) losses as the user selects third-party services. The lenders could improve their regulatory compliance by eliminating change circumstance validation. Further, third-party service providers like insurance providers, Title/Escrow companies may benefit from the comparison service by getting additional business from the users and lenders.

Advantageously, the system and method of the present invention provides a Compare-as-a-Service (CFAAS) that enables customers to digitally compare up to three official loan estimates at a time to determine which lender or service provider best suits their needs. Using the comparison service and mortgage marketplace, the users could truly review seemingly dissimilar mortgage closing fees and select a different service provider where changes are permitted. The system offers a common mortgage marketplace for all customer lending needs. Further, the system allows the user to digitally compare every required service and select the lowest-cost or quickest option, thereby allowing the user to shop all services at the same time without any delay.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system for providing various comparison services of industry-specific contextual text and official loan estimate in a mortgage marketplace, comprising:
a computing device having a processor and a computer-readable medium coupled to the processor, wherein the computer-readable medium comprises a set of instructions executable by the processor configured to perform various comparison services for industry-specific contextual text and official loan estimate from a plurality of lenders/service providers;
a database in communication with the computing device via a network configured to store a plurality of information used to perform various comparison services, and
a user device associated with each user or borrower in communication with the computing device via the network configured to allow the user to shop for all service providers in one centralized location,
wherein the computing device is configured to;
provide a side-by-side comparison for official loan estimate to assist the user to find out a lender having most beneficial mortgage offer, and
allow the user to compare the industry-specific contextual text along with an element of time that is relevant to the compared text, thereby allowing the user to determine the comparison parameters and contextual text relevance to overall comparison in order to select a suitable lender for an appropriate interest rate and all other mortgage services.

2. The system of claim 1, wherein the user device is configured to communicate with the computing device via the network using an application software or mobile application or web-based application or desktop application executed in a computer-implemented environment or network environment.

3. The system of claim 1, wherein the user device is at least any one of a smartphone, a mobile phone, a tablet, a laptop, a desktop, or any other suitable electronic communication devices.

4. The system of claim 1, further comprises a mortgage comparison module configured to provide comparison of a plurality of third-party services.

5. The system of claim 4, wherein the plurality of third-party services are title insurance, escrow and closing services, homeowners' insurance, inspection services, and mobile notary services.

6. The system of claim 1, wherein the mortgage marketplace includes a plurality of options include lenders, insurance providers, title/escrow companies, and inspection vendors.

7. The system of claim 1, further comprises an artificial intelligence (AI) module that evaluates each official loan estimate to identify unallowable fees and analyze fee amounts to alert the user in case of unallowable or exorbitant fees is present.

8. The system of claim 1, eliminates over tolerance (OT) losses of lenders participating in the mortgage marketplace as the user selects third-party services.

9. The system of claim 1, allows the lenders to improve their regulatory compliance by eliminating change circumstance validation.

10. The system of claim 1, enables users to digitally compare two or more official loan estimates at a same time to determine a suitable lender or service provider.

11. The system of claim 1, assists the user to get the suitable service provider and pricing and the lender to mitigate their risk by reducing or eliminating any losses stemming from any fee changes.

12. The system of claim 1, utilizes one or more push notifications including planned and unplanned events to inform the user during rate-impacting events.

13. The system of claim 1, allows the user to compare every required service and select the lowest-cost or quickest option, thereby allowing the user to shop all services at the same time without any delay.

14. A method for providing various comparison services for industry-specific contextual text and official loan estimate in a mortgage marketplace using a computer-implemented system that is executed in a network environment comprising a computing device having a processor coupled with a computer-readable medium that stores a set of instructions executable by the processor configured to perform various comparison services for industry-specific contextual text and official loan estimate from a plurality of lenders; a database in communication with the computing device via a network configured to store a plurality of information used to perform various comparison services, and a user device associated with each user or borrower in communication with the computing device via the network configured to allow the user to shop for all service providers in one centralized location, wherein the method comprises the steps of:
providing a side-by-side comparison of official loan estimates from two or more lenders to assist the user to find out a lender having most beneficial mortgage offer, and
allowing the user to compare the industry-specific contextual text along with an element of time that is relevant to the compared text, thereby allowing the user to determine the comparison parameters and contextual text relevance to overall comparison in order to select a suitable lender for an appropriate interest rate and all other mortgage services.

15. The method of claim 14, further compares a plurality of third-party services using a mortgage comparison module.

16. The method of claim 15, wherein the plurality of third-party services are title insurance, escrow and closing services, homeowners' insurance, inspection services, and mobile notary services.

17. The method of claim 14, wherein the mortgage marketplace includes a plurality of options include lenders, insurance providers, title/escrow companies, and inspection vendors.

18. The method of claim 14, enables users to digitally compare two or more official loan estimates at a same time to determine a suitable lender or service provider.

19. The method of claim 14, assists the user to get the suitable service provider and pricing and the lender to mitigate their risk by reducing or eliminating any losses stemming from any fee changes.

20. The method of claim 14, allows the user to compare every required service and select the lowest-cost or quickest option, thereby allowing the user to shop all services at the same time without any delay.
